(19) United States
(12) Patent Application Publication
(10) Pub. No.: US 2005/0023256 A1
(43) Pub. Date: Feb. 3, 2005

(54) 3-D adaptive laser powder fusion welding

(76) Inventors: Srikanth Sankaranarayanan, Greer, SC (US); James M. Hussey, Corinth, TX (US); Gary L. Winchester, Greer, SC (US); William Hehmann, Greer, SC (US)

Correspondence Address: HONEYWELL INTERNATIONAL INC., 101 COLUMBIA ROAD, P O BOX 2245, MORRISTOWN, NJ, 07962-2245, US

(21) Appl. No.: 10/632,451

(22) Filed: Jul. 31, 2003

(51) Int. Cl. B23K 26/34; G06F 19/00

(52) U.S. Cl. 219/121.63; 219/121.82; 219/121.83; 700/119

(57) ABSTRACT

A 3-D adaptive laser powder fusion welding system provides for both modeling/gauging of a workpiece as well as repair, restoration, and/or manufacture thereof. By providing a work platform and apparatus support system, five degrees of control in the form of two linear axes and three rotational axes are provided. The sixth linear axis is controlled via the displacement of a laser powder fusion (LPF) welding head and a laser rangefinding head. The laser rangefinding head system enables the workpiece W to be modeled electronically or otherwise. Additionally, the rangefinding system enables a model part to serve as a template from which repairs or construction are affected. The LPF welding head then affects any repairs or manufacture that are needed on the workpiece W. The LPF welding head is powered by filler material. The entire system is generally controlled by computer which enable the operator to be separated from a generally hot and hostile welding environment.

### CROSS-REFERENCES TO RELATED APPLICATIONS

This patent application is related to, but claims no priority from, U.S. Pat. Ser. No. 10/071,025 filed Feb. 8, 2002 for Hand Held Laser Powder Fusion Welding Torch and U.S. Pat. Ser. No. 10/206,411 filed Jul. 26, 2002 for Powder Feed Splitter for Hand-Held Laser Powder Fusion Welding Torch, which are incorporated by reference.

### COPYRIGHT AUTHORIZATION

Portions of the disclosure of this patent document may contain material which is subject to copyright and/or mask work protection. The copyright and/or mask work owner has no objection to the facsimile reproduction by anyone of the patent document or the patent disclosure, as it appears in the Patent and Trademark Office patent file or records, but otherwise reserves all copyright and/or mask work rights whatsoever.

### BACKGROUND OF THE INVENTION

1. Field of the Invention

This invention relates to Laser Powder Fusion Welding (LPFW) Systems and more particularly to a platform system for a Laser Powder Fusion Welding System enabling the workpiece to be disposed with respect to the laser head according to the six usual axes (roll, pitch, yaw, and x, y, z) as well as a teaching tool in order to affect repair and to provide three-dimensional data entry for the laser welding head.

2. Description of the Related Art

In the past, developments regarding Laser Powder Fusion Welding (LPFW) have been on a primitive or preliminary basis. Generally, the workpiece is held stationary while a moveable LPFW head is then applied in order to construct, fabricate, or repair the workpiece. In some circumstances, the table or platform upon which the workpiece rests may be rotated and the workpiece constructed or worked upon in the matter of a potter's wheel or similar.

Such geometrical disposition between the generally stationary workpiece and the moveable LPFW head constrains the types of articles that can be fabricated and/or repaired by the LPFW head. Certain angles and dispositions between the workpiece and LPFW head more readily accommodate the specific geometries of the workpiece and may enable better LPFW head functioning and performance in order to achieve the goals of the LPFW process. Current means do not allow for significant workpiece manipulation for engagement by the LPFW head or significant LPFW head manipulation for workpiece engagement.

LPFW Welding is particularly advantageous for certain materials that are not readily welded by other means. Components needing LPFW often exhibit variation from nominal surface contours in excess of what the welding process will tolerate. This causes or may lead to a higher probability of defect rates or the inability to use LPFW at all unless the components are machined prior to welding in a manner that minimizes such variation. Such additional operations increase cost due to the added labor and material. They also increase the time it takes to operate on the workpiece.

Currently, there are no machines or processes available to adapt to multi-dimensional part variability. It is generally well known that most high temperature super alloys (including those with refractory metals) are defined as “non-weldable” by conventional welding methods. Existing laser welding systems do not have the capability to trace and program a complex geometry for a part in a manner that positions the laser normal to the surface in a constant fixed distance during LPF (Laser Powder Fusion) welding.

In view of the foregoing, there is a need for providing an LPF system that can engage a dimensionally-variable part for both welding and tracing. Such a system could provide for greater reliability in part repair and enable LPF welding to be applied to super alloys or refractory materials.

### SUMMARY OF THE INVENTION

In view of the foregoing disadvantages, the 3-D adaptive laser powder fusion welding system set forth herein provides means by which multi-dimensional parts can be traced for welding and welded despite significant variability in the part's geometry. Additionally, beyond the tracing function which enables a three-dimensional modeling of a part, laser powder fusion (LPF) welding can then be applied to a part that departs from a model that has either been traced before or is otherwise available as a model.

By bringing LPF welding to bear upon such variable geometry parts, the use of refractory materials or super alloys may become more readily available as the barriers to use of such materials that arise from their “unweldable” nature by conventional means is overcome by the use of LPF welding.

The 3-D adaptive laser powder fusion welding system set forth herein provides means by which a model parts can be traced and archived for future reference. Such archiving of models occurs in a 3-D representation in an information storage device, such as a computer. Additionally, Laser Powder Fusion Welding (LPFW) is achieved by a laser welding head. A staging apparatus enables articulation of a workpiece in the six classical axes: x, y, and z as well as roll, pitch, and yaw. Consequently, the three spatial and three angular axes are enabled so that the laser powder fusion welding head can perform laser powder fusion welding activities on the workpiece. The stage also provides means by which the laser range finding head can perform its tracing and archiving functions.

By providing such a system, “golden” parts can be imaged, modeled, or otherwise archived to memory. Once modeled electronically or digitally, the electronic model representation can then be transmitted to other laser powder fusion welding systems so that repairs and operations can be performed anywhere according to a model that may also be archived locally or far away, even on another continent. In fact, a high-resolution tracing center for parts could provide the electronic templates for worldwide manufacture and repair.

By providing such a system, manufacture, alteration, and repair of parts that are subject to laser powder fusion welding are readily and easily achieved. Furthermore, those materials which are generally not subject to regular welding processes are now opened up for commercial and technical exploitation due to the removal of the prior obstacle of not being susceptible to normal welding processes.

In one embodiment, the 3-D adaptive laser powder fusion welding system subjects a workpiece to laser powder fusion welding via a laser head system and a linear displacement element coupled to the laser head and enabling the laser head to be displaced linearly in a first dimension. A support apparatus holds the workpiece adjacent the laser head in an adjustable and selectable manner and provides five degrees of freedom for the workpiece in second and third linear dimensions and first, second, and third rotational dimensions. In this way; the laser head may engage the workpiece about its exterior. By so engaging the workpiece, the welding system enables welding to occur at almost any, if not every, surface of the workpiece.

In another embodiment, the 3-D adaptive laser powder fusion welding system subjects a workpiece to laser powder fusion welding via a laser head system that includes a laser welding head, a powder feed delivery system, and a tracing system that determines the topology of the workpiece. A linear displacement element coupled to the laser head enables the laser head to be displaced linearly in a first dimension and a support apparatus holds the workpiece adjacent the laser head in an adjustable and selectable manner. The support apparatus provides five additional degrees of freedom for the workpiece in second and third linear dimensions and first, second, and third rotational dimensions. The support apparatus including an x-axis prismatic element enabling linear travel along a first linear axis, a y-axis prismatic element enabling linear travel along a second linear axis, a roll revolute element enabling angular travel centered upon a roll axis, a pitch revolute element enabling angular travel centered upon a pitch axis, a yaw revolute element enabling angular travel centered upon a yaw axis. The x-axis, y-axis, roll revolute element, pitch revolute element, and yaw revolute elements are coupled to one another. A filler delivery system providing filler material to the laser head system. A laser supplying laser light to the laser head system is included and may generally rely upon an Nd-YAG laser. Alternative sources of laser energy may also be used, including lasers based on or using carbon dioxide (CO₂) and/or yttrium fiber diode laser systems. A controller system controls operation of the filler delivery system, the laser, the laser head system, the linear displacement element, and the support apparatus. The controller system includes: a digital servo amplifier system coupled to the support apparatus and controlling operation of the five degrees of freedom; a robot controller coupled to and controlling the laser head system, the linear displacement element, and the digital servo amplifier; and a computer programmably operating the robot controller and enabling recording of data through the controller system. The 3-D LPF system is able to engage the workpiece about an exterior of the workpiece and by so engaging the workpiece, the welding system enables welding to occur at almost any, if not every, surface of the workpiece.

Other features and advantages of the present invention will become apparent from the following description of the preferred embodiments taken in conjunction with the accompanying drawing which illustrates, by way of example, the principles of the system set forth herein.

### BRIEF DESCRIPTION OF THE DRAWINGS

FIG. 1 shows a schematic diagram of the 3-D adaptive laser powder fusion welding system set forth herein with the central positioning table and related welding equipment being generally circumscribed in schematic form by control and communication elements.

FIG. 2 is an enlarged portion of FIG. 1 as designated by the dashed box in FIG. 1.

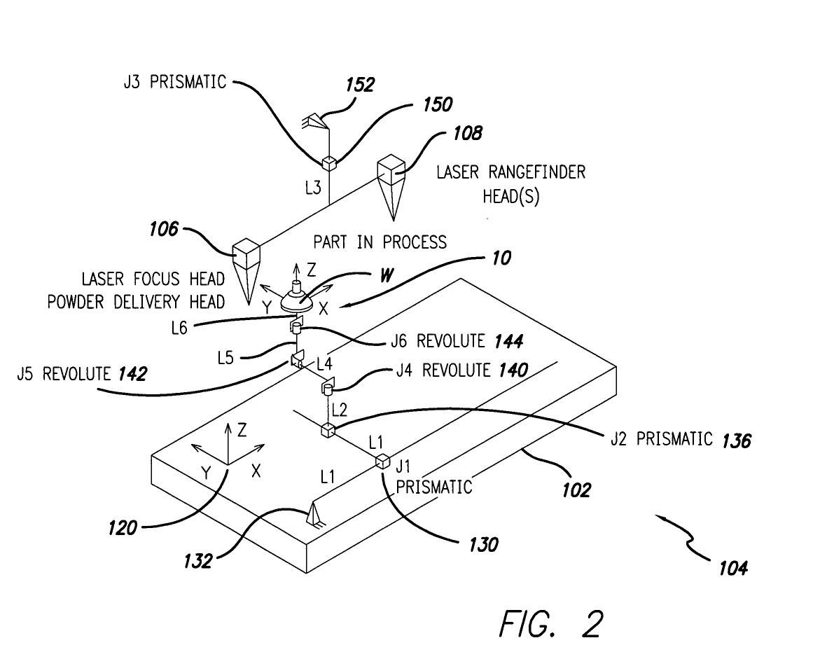

### DESCRIPTION OF THE PREFERRED EMBODIMENT(S)

The detailed description set forth below in connection with the appended drawings is intended as a description of presently-preferred embodiments of the invention and does not represent the only forms in which the present invention may be constructed and/or utilized. The description sets forth the functions and the sequence of steps for constructing and operating the invention in connection with the illustrated embodiments. However, it is to be understood that the same or equivalent functions and sequences may be accomplished by different embodiments that are also intended to be encompassed within the spirit and scope of the invention.

The 3-D adaptive laser powder fusion welding system 100 has a central table or platform 102 upon which geometrical control elements (generally indicated as 104) operate in order to dispose a workpiece W in relation to either a laser powder fusion welding head 106 or a laser rangefinder head 108. The geometrical control elements 104 generally control five of the six available axes as used herein, these axes are the three lateral axes generally known in the art as x, y, and z that define a three-dimensional space as well as the three rotational axes commonly known as roll, pitch, and yaw. The geometrical control elements 104 associated with the table 102 operate to control the three rotational and the two lateral, x and y, directions of linear displacement. The third axis of linear displacement is controlled by the height at which either the LPFW head 106 or laser rangefinder 108 are disposed with respect to the workpiece W.

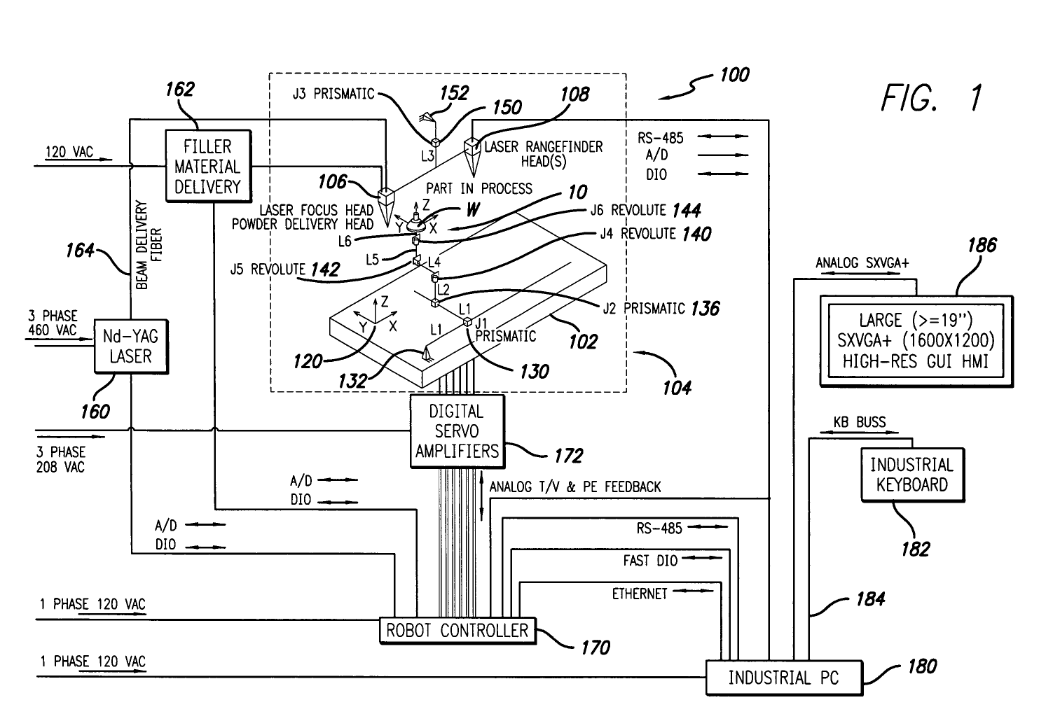

Generally the linear components are those of high precision and are generally known in the art. As indicated in FIG. 1, the term “prismatic” generally indicates linear directions of travel. The term “revolute” indicates an angular displacement control. For the prismatic/linear elements to the geometrical controls 104, high precision servomotors and the like can be used in order to precisely and accurately control the linear travel of the support apparatus 110. The support apparatus includes the geometrical control elements as well as any intermediating support elements that serve to displace one geometrical control element from another.

Similarly, high precision and high accuracy servomotors may serve to provide angular displacement for the revolute elements in the system 100. Similar to the prismatic elements associated with the support apparatus 110, prismatic element may also be used in conjunction with the laser heads 106, 108.

Turning now to the details of the table 102, the set of axes 120 are shown both in association with the table 102 and the workpiece W. These axes define similar geometries and are assumed to be identical save for the lateral displacement between the origin of the two. Consequently, use of the terms x, y, and z axes as well as roll, pitch, and yaw are generally relative to the axes 120 shown in FIG. 1. Roll is generally considered to be movement around the x-axis or a roll axis, pitch is motion rotating generally upon the y-axis or pitch axis, while yaw is angular motion rotating generally upon the z-axis or yaw axis. The definition of these rotational axes may be relative to the workpiece W as opposed to the table 102.

On the table 102, a first linear displacement element 130 is shown supported above the surface of the table 102 by a post or other support 132. The linear displacement element for the x-axis 130 is also indicated in the drawing FIG. 1 as “J1 Prismatic”. The x-axis linear displacement element 130 travels along a rod, screw, path, or otherwise in a manner parallel to the x-axis 120 generally along one side of the table 102. This leaves the rest of the table space available for motion along the y-axis 120. While not shown in FIG. 1 for drawing purposes, the x-axis linear displacement element 130 travels above the surface of the table as held by the rod or otherwise. The same is similarly true for the other elements of the support apparatus 110 with its geometrical control elements 104.

Coupled to the x linear displacement element 130 is a y linear displacement element 136 which is also indicated in FIG. 1 as “J2 Prismatic”. In a manner similar to that for the x-axis linear displacement element 130, the y-axis linear displacement element 136 travels parallel to the y-axis 120 in the same way that the x linear displacement element 130 travels parallel to the x-axis 120. The x and y linear displacement elements 130, 136 may have a total possible distance of travel along predefined paths of a certain length designated in FIG. 1 as L1. This generally defines a square area having sides of equal length and right angles to each other on which the workpiece W may travel. L1 may be an arbitrarily chosen distance for the types of workpieces W to be handled in the system 100 set forth herein. Alternatively, such distances may be different for the x linear displacement element 130 and the y linear displacement element 136. If the x and y available travel distances are not equal, the resulting area defined by the x and y linear displacement elements 130, 136 is a rectangle.

With the foundational definition of x-axis and y-axis degrees of freedom for the workpiece W via the x and y linear displacement elements 130, 136, additional rotational elements provide angular control for roll, pitch, and yaw axis for the workpiece W.

Separated from the y linear displacement element 136 by an appropriately chosen distance L2, a yaw control 140 (J4 Revolute) enables the workpiece W to enjoy angular displacement about the z-axis 120. Similarly, a pitch control 142 (J5 Revolute) provides angular displacement with respect to the y-axis 120. The pitch control 142 may be separated from the yaw control 140 by a distance L4.

A roll control element 144 (J6 Revolute) may control rotational displacement about the x-axis. The workpiece study of itself may be coupled to the roll control 144 by means of a support having a distance L6 or otherwise.

Note should be taken, that the distances between the y linear displacement element 136 and the yaw, pitch, and roll elements 140, 142, 144 may also be variable in distance such that distances L2, L4, L5, and L6 may be varied according to pre-selected and adjustable distance controls.

From the foregoing, it can be seen that the disposition of the workpiece W is controlled in generally five dimensions: two linear (x and y) and three angular (roll, pitch, and yaw). In order to provide for control over the sixth axis, namely displacement along the z-axis 120, z linear displacement element 150 (J3 Prismatic) is coupled to both the laser powder fusion welding head 106 and the laser rangefinder head 108 as the two laser heads, 106, 108 are disposed in a generally perpendicular manner to the z-axis linear displacement element 150 and so generally always enjoy the same height above the table 102.

The z-axis linear displacement element may be coupled to a structure or support that is coupled to the table 102. For purposes of visual depiction, a post 152 is shown connected to a background substrate which gives ultimate support to the laser heads 106, 108.

The laser heads 106, 108 are significantly different in nature. The laser powder fusion welding head 106 is significantly energetic in order to melt a number of materials including plastics and metals. Consequently, the LPF welding head 106 is much more industrial in nature as it needs to resiliently withstand the dynamic and generally hostile environment that arises from laser powder fusion welding. As indicated in FIG. 1, the LPF Welding head 106 may be powered by an Nd-YAG (neodymium-yttrium-aluminum garnet) laser 160 which provides sufficient power to the LPF head 106 in order to meld, melt and/or weld the materials used thereby. Alternative sources of laser energy may also be used, including lasers based on or using carbon dioxide (CO₂) and/or yttrium fiber diode laser systems. Such material is delivered by a filler material delivery system 162 which may be operated in accordance with the needs and demands of the workpiece W and the welding thereof by the LPF Welding head 106. The same is similarly true for the laser 160 where the energy arising from the laser 160 is selectably controllable in order to provide better and more adjustable welding for the workpiece W.

Laser 160 and filler material delivery systems 162 are known in the art but may also be derived from previously filed patent applications assigned to the same assignee as the present technology. U.S. patent application Ser. No. 10/071,025 filed on Feb. 8, 2002 entitled Hand-Held Laser Powder Fusion Welding Torch by Baker et al. is incorporated by reference. U.S. patent application Ser. No. 10/206,411 filed Jul. 26, 2002 for a Powder Feed Splitter for Hand-Held Laser Powder Fusion Welding Torch by Renteria et al. is incorporated by reference.

The laser light from the laser 160 may be delivered to the LPF Welding head 106 by a beam delivery fiber system 164 that optically transmits laser energy from the laser to the LPF Welding head 106. Other means by which the laser energy may be delivered to the LPF Welding head 106 may also substitute for fiber optics.

The laser rangefinder head system 108 may include one or more laser range finding heads (possibly powered in a diminished-energy mode by the laser 160) that enable the geometrical contours of the workpiece W to be modeled and then coded electronically into a computer or otherwise. Alternatively, a helium-neon (HeNe) laser system may be used, as may a contact type of scanning system, along the lines of RENISHAW or other part-measuring probes to obtain the geometry of a workpiece or template part. By having a model (particularly an exact, precise, and accurate model) of the workpiece W, the laser powder fusion welding head 106 can then operate with exact and reliable data of the contours of the workpiece W that either are present or that need to be achieved via the welding process.

As can be seen in FIG. 1, the laser heads 106, 108 generally do not enjoy any horizontal or lateral degree of freedom, but are only adjustable in the vertical, z-axis direction by the z-axis linear displacement element 150 (J3 prismatic). Consequently, it becomes an operation of the support apparatus 110 with its geometrical control elements 104 to dispose the workpiece W in proximity to the laser rangefinding head system 108. The laser rangefinder head system 108 can or completely determine the exterior geometry of the workpiece W for modeling purposes or otherwise. This is particularly advantageous when a model part is used for modeling and archiving. Such modeling is known in the art and, in summary, occurs when the rangefinding head system 108 determines the contours towards workpiece W as it is disposed along all three linear axes and all three rotational axes beneath the rangefinding system 108.

All of the geometrical control elements 104 of the support apparatus 110 as well as the z linear displacement element 150 are coupled to a robot controller 170 (such as one using Adept Windows by Adept Technologies, Inc.) via digital servo amplifiers 172 or the like. This enables machine control for the linear and rotational displacement systems 104, 150. The robot controller 170 may also receive information signals from the laser rangefinder head system 108, the LPF Welding head 106, the filler material delivery system 162, and the laser 160 via a variety of signal lines including analog/digital (A/D) signal lines and/or digital input output (DIO) signal lines. Signals are transferred and exchanged between the digital servo amplifiers 172 and the robot controller 170 subject to traffic across the connection between the two.

The degrees of freedom present in the support apparatus 110 may require the travel along two or more axes simultaneously to position the workpiece W properly. For example, if the workpiece W is rolled forward such that its top most portion now faces forward in the positive x direction, it may be necessary to decrease the displacement of the x linear displacement element 130 so that one of the laser heads 106, 108 is directly above the former top most portion of the workpiece (prior to rotation). Such adjustments are generally easily calculated once the equations of motion are known for the support apparatus 110 and such equations may take into account displacement of the workpiece W itself, not just the motion of the support apparatus 110.

The robot controller 170 may communicate with an industrial PC (personal computer) 180 or otherwise. A number of calls, signal schemes, and/or protocols may be used in order to conduct such communication (generally two way) between the controller 170 and the PC 180. These include: Ethernet, fast I/O, RS-485, analog TN and PE feedback, or otherwise. Other protocols developed in the future may also be advantageously implemented in the present system 100 in order to foster, establish, maintain, provide in a robust and reliable manner the signals necessary to monitor and control the processes going on and about the workpiece W.

In its turn, the industrial PC may be connected to an industrial keyboard 182 which may be connected to the PC 180 via a keyboard bus 184.

Visual monitoring of the process by transmission of video, digitized, or other sensor information can be achieved through a high-resolution or other graphics interface such as a super extended visual graphics array (SXVGA) monitor having a high-resolution display and, preferably a graphics user interface for the human machine interface (GUI HMI).

Generally, electronic control of machine elements is known in the art. However, the achievement of the present system 100 in providing a 3-D adaptive laser powder fusion welding system that both enables modeling and reconstruction/repair/manufacture of workpieces W provides significant advantages for LPFW Systems. The system 100 may be powered by a variety of sources with generally the following power requirements being contemplated. 120 volt AC (VAC) power generally supplies the filler material delivery system 162. One phase 120-volt AC power generally supplies the controller 170 and the PC 180 and related systems. Three phase 208 VAC may power the digital servo amplifiers 172. Three phase 460 VAC may power the laser 160.

Set forth below is a possible parts list that indicates devices that may be used to achieve one embodiment of this system

| Segment | Sector Name | Subsector Name | Component Name | Manufacturer |
|---|---|---|---|---|
| Controls | Computer Products | Industrial Computers | Motion Controller | Motion Engineering, Inc. |
| | Control Devices | Relay | Control Relay (Positive guided) | Siemens |
| | | | General Purpose Relay | Song Chuan |
| | | | Small Relay | Phoenix Contact |
| | | | Solid State Relay | Omron |
| | Electronic Devices | Electronic Filters | AC Line Filter | Corcom |
| | Operator Interface | Annunciators | Audible Alarm | Mallory |
| | | | Mast Component | Telemecanique |
| | | Pilot Devices | 22 mm Switch | Siemens |
| | PLC | | | Allen-Brady Co. |
| | Safety Components | Safety Components | Cable Pull Switch | Schmersal |
| | | | Guard Switch | Schmersal |
| | | | Light Curtain | Banner |
| | | | Safety Relay | Schmersal |
| | | | Touchswitch | Banner |
| | Sensors | Digital Sensors | Limit Switches-Mechanical | Baumer |
| | | | Optical Sensor | Efector, Inc. |
| | | | Proximity, Inductive | Efector, Inc. |
| | | Sensor Accessories | Sensor Accessories | Efector, Inc. |
| | | Sensor Cables | Sensor Cables | Efector, Inc. |
| Electrical | Cable & Wire | Cables | Custom Cables | Cameron & Barkley |
| | | | Data Highway Cable | Belden |
| | | | Ethernet Cable | Anicom, Inc. |
| | | | Flat Ribbon Cable | Alpha |
| | | | Molded Cable | L-Com |
| | | | Multi Conductor >20 awg | Olflex |
| | | | Multi Conductor High Flex | Olflex |
| | | | Multi-Conductor <20 awg | Olflex |
| | | Wire | Panel Wire | Carol |
| | Control Devices | Relays | Triac Relay | Omron |
| | Electronic Devices | Diodes | General Purpose Diode | Newark Electronics |
| | | | TB Diode | Phoenix Contact |
| | Enclosures & Wiring | Conduit | Aluminum Conduit | Shealy Electric Wholesale |
| | | | Conduit Fitting | Crouse-Hinds |
| | | | Flexible Conduit | Anaconda |
| | | | Galvanized Conduit | Shealy Electric Wholesale |
| | | | Plastic Coat Conduit | Ocal |
| | | | PVC Conduit | Carlon |
| | | | Steel Conduit | Shealy Electric Wholesale |
| | | Connectors | BNC Connector | L-COM |
| | | | Circular Connector | Amp |
| | | | D-Sub Connector | Amp |
| | | | Heavy Duty Connector | Harting |
| | | | Interface Module | Phoenix Contact |
| | | | Power Plug | Hubbell |
| | | | Power Receptacle | Hubbell |
| | | | Ribbon Connector | Amp |
| | | Enclosures | Climate Control | Rittal Corporation |
| | | | Console | Rittal Corporation |
| | | | Free-Standing Enclosure | Rittal Corporation |
| | | | Junction Box | Rittal Corporation |
| | | | Modular Enclosure | Rittal Corporation |
| | | | Operator Enclosure | Rittal Corporation |
| | | | PC Enclosure | Rittal Corporation |
| | | | Push Button Enclosure | Hoffman |
| | | | Wallmount Enclosure | Rittal Corporation |
| | | Graphics | Engraved Legend Plate | Panel Graphics, Inc. |
| | | Strain Reliefs | Strain Relief | Olflex |
| | | Terminal Blocks | Terminal Block | Phoenix Contact |
| | | Wire Accessories | Cable End | Telemecanique |
| | | | Cable End Marker | Telemecanique |
| | | | Cable Tie | Thomas & Betts |
| | | | Shrinkable Tubing | Alpha |
| | | | Wire Marker | Brady |
| | | | Wire Terminal | 3 M |
| | | Wireduct | Wireduct (Enclosure) | Iboco |
| | | | Fiberglass Wireway | Hoffman |
| | | | Stainless Wireway | Hoffman |
| | | | Steel Wireway | Hoffman |
| | Motor Controls | Contactors | Contactor | Siemens |
| | | Motor Overloads | Motor Overload | Siemens |
| | | Motor Starters | Motor Starter | Siemens |
| | Power Distribution | Busbars | Busbar | Siemens |
| | | Busducts | CE Busduct | Mempower |
| | | | UL Busduct | Siemens |
| | | Circuit Breakers | High Trip Breaker | Siemens |
| | | | Standard Trip Breaker | Siemens |
| | | Disconnects | Breaker Disconnect | Siemens |
| | | | Fused Disconnect | Siemens |
| | | | Knife Disconnect | Siemens |
| | | | Rotary Disconnect | Siemens |
| | | Fuse Holders | DIN Rail Fuse Holder | Gould |
| | | | Panel Mount Fuse Holder | Gould |
| | | Fuses | Blade-Type Fuse | Bussman |
| | | | Cartridge Fuse | Bussman |
| | | | Glass Fuse | Bussman |
| | | Distribution Blocks | Power Dist. Block | Gould |
| | | Power Supplies | DC Power Supply | Siemens |
| | | Surge Suppressors | Device Mount | Siemens |
| | | | TB Surge Suppressor | Phoenix Contact |
| | | Transformers | UL Control Transformer | Hevi-Duty |
| | | | UL Power Transformer | Acme |
| | | UPS | UPS | Best Power Technology |
| Mechanical | Conn. & Fastening | Air Service | AirLine Fittings | SMC |
| | | | AirLine, Plastic | Frelin Wade |
| | | | Fittings, SS | Weatherhead |
| | | | Miniature Fittings | SMC |
| | | | Tubing, SS, Rigid | H. M. Craig |
| | Mechanical Devices | Linear motion | Ball Screw Slides | Parker Autom |
| | | | Belt Slides | Parker Autom |
| | Pneumatic Items | Air Preparation | Filter\Regulator\Lubricator | SMC |
| | | Pneumatic Actuators | Cylinder & Accessories-Large | SMC |
| | | | Cylinder & Accessories-Small | SMC |
| | | | Grippers | Phd |
| | | | Pick & Place Units, >400 mm | Parker Autom |
| | | | Pick & Place Units, <400 mm | Precision Pneumatics |
| | | | Rodless Cylinders | SMC |
| | | | Rotary Actuators | SMC |
| | | | Slides & Thrusters | SMC |
| | | Vacuum products | Vacuum Cups | SMC |
| | | | Vacuum Generators | SMC |
| | | Valves | Ball Valves | SMC |
| | | | Flow Control Valves | SMC |
| | Power Transmission | Bearings/Bushings | Bearings, Ball | Various Brands |
| | | | Bearings, CamFollower | Various Brands |
| | | | Bearings, Linear, Round Shaft | INA |
| | | | Bearings, Linear, Square Rail | INA |
| | | | Bearings, Mtd, Ball | Various Brands |
| | | | Bearings, Mtd, Spherical Roller | Various Brands |
| | | | Bearings, Mtd, Takeup | Various Brands |
| | | | Bearings, Mtd, Tapered Roller | Various Brands |
| | | | Bearings, Needle | Various Brands |
| | | | Bearings, RodEnd | Various Brands |
| | | | Bushing, Composite | Various Brands |
| | | | Bushing, Spherical | Various Brands |
| | | | Bushing, Plain | Various Brands |
| | | Hardware | Collars | Various Brands |
| | | | Clamps | Various Brands |
| | | Motors | AC Motor up to 3 HP | US Motor |
| | | Power Transmission | Belts, timing | Various Brands |
| | | | Belts, Vee | Various Brands |
| | | | Chain | Various Brands |
| | | | Clutches | Various Brands |
| | | | Couplings | Various Brands |
| | | | Joints | Various Brands |
| | | | Gear drives | Various Brands |
| | | | Gear Motors | Various Brands |
| | | | Sheaves, Pulleys & Hubs, Belt | Various Brands |
| | | | Sprockets & Hubs, Chain | Various Brands |
| | | | Gaskets | Various Brands |
| | | | 0-Rings | Various Brands |
| | | Sealing | Seals | Various Brands |
| | Structural Products | Extrusion Accessories | Strut Accessories | Parker ParFrame |
| | | Extrusions | Strut & Extrusions | Parker ParFrame |
| | | Plastics | Plastic | Sheffield |
| Systems | Air Systems | | Vacuum Generators, Large | SMC |
| | Coveyors | Belt/Roller Conveyors | Conveyors, Other | EASI Conveyors |
| | | | Conveyors, Custom | A&E |
| | | | Conveyors, Industrial | A&E |
| | | Power&Free Conveyors | Conveyors, Flexible Chain | AMC |
| | | | Conveyors, Power & Free | AMC |
| | Feeding Systems | Feeding Systems | Centrifugal Feeders | VIBROMATIC |
| | | | Feeders, Other | VIBROMATIC |
| | | | InFeed Tables/Conveyors | VIBROMATIC |
| | | | Vibratory Feeders | VIBROMATIC |
| | Robotics | Robotics | Robots, Cartesian | Parker Autom |
| | | | Robots, Gantry, Light & Med | Parker Daedal |
| | | | Servo Driven Pick & Place | Parker Autom |

While the present invention has been described with reference to a preferred embodiment or to particular embodiments, it will be understood that various changes and additional variations may be made and equivalents may be substituted for elements thereof without departing from the scope of the invention or the inventive concept thereof. In addition, many modifications may be made to adapt a particular situation or material to the teachings of the invention without departing from the essential scope thereof. Therefore, it is intended that the invention not be limited to particular embodiments disclosed herein for carrying it out, but that to the invention includes all embodiments falling within the scope of the appended claims.

1. A 3-D adaptive laser powder fusion welding system for subjecting a workpiece to laser powder fusion welding, the system comprising:
a laser head system;
a linear displacement element coupled to the laser head and enabling the laser head to be displaced linearly in a first dimension; and
a support apparatus capable of holding the workpiece adjacent the laser head in an adjustable and selectable manner, the support apparatus providing five degrees of freedom in second and third linear dimensions and first, second, and third rotational dimensions; whereby
the laser head may engage the workpiece about an exterior of the workpiece.

2. A 3-D adaptive laser powder fusion welding system for subjecting a workpiece to laser powder fusion welding as set forth in claim 1, wherein the laser head system further comprises:
a laser welding head.

3. A 3-D adaptive laser powder fusion welding system for subjecting a workpiece to laser powder fusion welding as set forth in claim 1, wherein the laser head system further comprises:
a powder feed delivery system.

4. A 3-D adaptive laser powder fusion welding system for subjecting a workpiece to laser powder fusion welding as set forth in claim 1, wherein the laser head system further comprises:
a tracing system determining topology of a workpiece.

5. A 3-D adaptive laser powder fusion welding system for subjecting a workpiece to laser powder fusion welding as set forth in claim 1, wherein the tracing system further comprises:
a laser rangefinder.

6. A 3-D adaptive laser powder fusion welding system for subjecting a workpiece to laser powder fusion welding as set forth in claim 1, wherein the support apparatus further comprises:
an x-axis prismatic element enabling linear travel along a first linear axis;
a y-axis prismatic element enabling linear travel along a second linear axis;
a roll revolute element enabling angular travel centered upon a roll axis;
a pitch revolute element enabling angular travel centered upon a pitch axis; and
a yaw revolute element enabling angular travel centered upon a yaw axis;
the x-axis, y-axis, roll revolute element, pitch revolute element, and yaw revolute elements coupled to one another.

7. A 3-D adaptive laser powder fusion welding system for subjecting a workpiece to laser powder fusion welding as set forth in claim 1, further comprising:
a filler delivery system providing filler material to the laser head system;
a laser supplying laser light to the laser head system; and
a controller system controlling operation of the filler delivery system, the laser, the laser head system, the linear displacement element, and the support apparatus.

8. A 3-D adaptive laser powder fusion welding system for subjecting a workpiece to laser powder fusion welding as set forth in claim 7, wherein the laser further comprises a laser selected from the group consisting of:
an Nd-YAG laser;
a CO₂ laser; and
an ytterbium fiber diode laser system.

9. A 3-D adaptive laser powder fusion welding system for subjecting a workpiece to laser powder fusion welding as set forth in claim 7, wherein the controller system further comprises:
a digital servo amplifier system coupled to the support apparatus and controlling operation of the five degrees of freedom.

10. A 3-D adaptive laser powder fusion welding system for subjecting a workpiece to laser powder fusion welding as set forth in claim 7, wherein the controller system further comprises:
a robot controller coupled to and controlling the laser head system, the linear displacement element, and the support apparatus.

11. A 3-D adaptive laser powder fusion welding system for subjecting a workpiece to laser powder fusion welding as set forth in claim 7, wherein the controller system further comprises:
a computer programmably operating the controller system and enabling recording of data through the controller system.

12. A 3-D adaptive laser powder fusion welding system for subjecting a workpiece to laser powder fusion welding, the system comprising:
a laser head system including a laser welding head, a powder feed delivery system, and a tracing system determining topology of a workpiece;
a linear displacement element coupled to the laser head and enabling the laser head to be displaced linearly in a first dimension; and
a support apparatus capable of holding the workpiece adjacent the laser head in an adjustable and selectable manner, the support apparatus providing five degrees of freedom in second and third linear dimensions and first, second, and third rotational dimensions, the support apparatus including an x-axis prismatic element enabling linear travel along a first linear axis, a y-axis prismatic element enabling linear travel along a second linear axis, a roll revolute element enabling angular travel centered upon a roll axis, a pitch revolute element enabling angular travel centered upon a pitch axis, a yaw revolute element enabling angular travel centered upon a yaw axis, the x-axis, y-axis, roll revolute element, pitch revolute element, and yaw revolute elements coupled to one another;
a filler delivery system providing filler material to the laser head system;
a laser supplying laser light to the laser head system, the laser including a laser selected from the group consisting of:
an Nd-YAG laser;
a CO2 laser; and
an ytterbium fiber diode laser system; and
a controller system controlling operation of the filler delivery system, the laser, the laser head system, the linear displacement element, and the support apparatus, the controller system including:
a digital servo amplifier system coupled to the support apparatus and controlling operation of the five degrees of freedom;
a robot controller coupled to and controlling the laser head system, the linear displacement element, and the digital servo amplifier; and
a computer programmably operating the robot controller and enabling recording of data through the controller system; whereby the laser head may engage the workpiece about an exterior of the workpiece.

13. A 3-D adaptive laser powder fusion welding system for subjecting a workpiece to laser powder fusion welding as set forth in claim 12, wherein the tracing system further comprises:
a laser rangefinder.
